(19) United States
(12) Patent Application Publication
(10) Pub. No.: US 2014/0297669 A1
(43) Pub. Date: Oct. 2, 2014

(54) Attract mode operations associated with virtual tagging

(71) Applicant: BROADCOM CORPORATION, Irvine, CA (US)

(72) Inventors: Yasantha Nirmal Rajakarunanayake, San Ramon, CA (US); James Duane Bennett, Hroznetin (CZ); Wael William Diab, San Francisco, CA (US)

(73) Assignee: BROADCOM CORPORATION, IRVINE, CA (US)

(21) Appl. No.: 13/868,293

(22) Filed: Apr. 23, 2013

Related U.S. Application Data
(60) Provisional application No. 61/806,589, filed on Mar. 29, 2013.

(51) Int. Cl. G06F 17/30

(52) U.S. Cl. CPC G06F 17/30386
USPC 707/756; 707/736

(57) ABSTRACT

A method and system for drawing roaming users to a particular virtually tagged location based on associated geolocation virtual tags. Notifications are provided to the user of a mobile communications device at a first location to attract the user to a second location having associated virtual tags. For example, a series of virtual tags trigger at different distance intervals from the virtually tagged posting location to provide the user with periodic directions (i.e., arrows, audible “turn left here”, “only 100 m away”, etc.) drawing the roaming user to the virtually tagged location. Various modes of operation provide the roaming user with customizability based on individual characteristics, behaviors and preferences.

### CROSS REFERENCE TO RELATED APPLICATIONS

The present U.S. Utility patent application claims priority pursuant to 35 U.S.C. §119(e) to the following U.S. Provisional Patent Application Ser. No. 61/806,589, entitled “Attract Mode Operations Associated with Virtual Tagging,” (Attorney Docket No. BP31924) filed Mar. 29, 2013, pending, which is hereby incorporated herein by reference in its entirety and made part of the present U.S. Utility patent application for all purposes.

### BACKGROUND OF THE INVENTION

1. Technical Field of the Invention

This technology described herein relates generally to internet searching infrastructures and more particularly to geo-based virtual tagging of internet content.

2. Description of Related Art

Today, a large amount of Internet searching is performed from a remote location using portable or hand-held mobile communication devices. These devices are often equipped with cameras and global positioning system (GPS) sensors providing the user with access to web-based information based on their physical proximity. In a process called geo-tagging, information such as photos, videos, websites, and other forms of media can be provided along with geospatial metadata. This data typically comprises latitude and longitude coordinates, however it is can also include altitude, bearing, distance, accuracy data as well as location names. Recent technological improvements have enhanced the interaction between geo-tagged data and mobile communication devices.

Current approaches to geo-tagging typically limit the amount of information available to display in a real-world environment. Conventional search infrastructures, such as Google and Bing, crawl web hosting servers to gather web page text and associated media content. Such gathered text and data are preprocessed to extract search database content and cached to support search results when a server is out of action or a graphic image is retrieved. If a user desires to make content available on the Internet, they must either establish a web server or upload their content to a web server based hosting service.

These limitations carry beyond users searching for information within close proximity. Often, users want to perform proximity based searches outside of their immediate location. Conventional systems as described above retrieve information based on the user's proximity where the results can be refined based on other search criteria (i.e., other key terms, dates, content type). This approach limits the relevant information that can be accessed by roaming users as well as having a significant impact of business opportunities for merchants and other businesses that rely on proximity based advertisements and referrals.

Disadvantages of conventional approaches will be evident to one skilled in the art when presented in the disclosure that follows.

### BRIEF DESCRIPTION OF THE SEVERAL VIEWS OF THE DRAWING(S)

The technology described herein is directed to an apparatus and methods of operation that are further described in the following Brief Description of the Drawings and the Detailed Description of the Invention. Other features and advantages will become apparent from the following detailed description made with reference to the accompanying drawings.

FIG. 1 is a system diagram illustrating one embodiment of the technology described herein;

FIG. 2 illustrates a flow diagram showing one embodiment of the technology described herein of creating a geolocation virtual tag and providing the geolocation virtual tag to selected targets;

FIG. 3 illustrates one embodiment of the technology described herein of receiving geolocation virtually tagged information based on location;

FIG. 4 illustrates a screen shot illustrating one embodiment of the technology described herein of a geolocation virtual tag posting interface including selection of files;

FIG. 5 illustrates a screen shot illustrating one embodiment of the technology described herein of a geolocation virtual tag posting interface including selection of access restrictions;

FIG. 6 illustrates a screen shot illustrating one embodiment of the technology described herein of a geolocation virtual tag posting interface including selection of update modes;

FIG. 7 illustrates a flow diagram showing one embodiment of the technology described herein of a geolocation virtual tag retrieval including setting of user preferences;

FIG. 8 illustrates a screen shot illustrating one embodiment of the technology described herein of a geolocation virtual tag search interface including user preference setting of timing;

FIG. 9 illustrates a screen shot illustrating one embodiment of the technology described herein of a geolocation virtual tag search interface including user preference setting of coverage;

FIG. 10 illustrates a screen shot illustrating one embodiment of the technology described herein of a geolocation virtual tag search interface including user preference setting of frequency;

FIG. 11 illustrates a screen shot illustrating one embodiment of the technology described herein of a geolocation virtual tag search interface including user preference setting of filters;

FIG. 12 illustrates a screen shot illustrating one embodiment of the technology described herein of a geolocation virtual tag search interface including user preference setting of alerts;

FIG. 13 illustrates a screen shot illustrating one example embodiment of the technology described herein of a geolocation virtual tag posting;

FIG. 14 illustrates a screen shot illustrating one example embodiment of the technology described herein of a received geolocation virtual tag; and

FIG. 15 illustrates a plurality of screen shots illustrating one embodiment of the technology described herein of a multi-level geolocation virtual tag strategy.

FIG. 16 illustrates one embodiment flow diagram of using the search infrastructure of the technology described herein.

### DETAILED DESCRIPTION OF THE INVENTION

A system and method is provided to support geolocation virtual tagging. Geolocation virtual tagging allows users via, for example, hand-held devices (smartphones, cameras, tablets, etc.), to annotate various geo-locations around the world. A virtual tag might be, for example, a text note praising a current restaurant (posted at such restaurant), a photo taken atop the Eiffel Tower at night, a Macy's parade video and text note, a text note on a hiking trail advertising a local café, or the like. Each of such virtual tags, upon posting, receives an associated geolocation. In this way, virtual tags can annotate the world. With such annotations, a user at a particular geolocation can use their mobile communications device to access virtual tags in geo-proximity. Annotations are supplied to the system by users via posting uploads directly from the user's mobile communications device. A search infrastructure stores each virtual tag posting element along with an associated geolocation. The associated geolocations are added to a geo-location search database along with pointers to the stored elements.

Attract mode geolocation virtual tagging includes creating, editing, selecting, storing and managing geolocation virtual tags to induce a specific behavior from users within a geographic area. For example, in one embodiment, a restaurant creates, using their geolocation, a virtual tag which the system will push (transmit) out to users within proximity (e.g., 1 mile or less) to their restaurant. In this example, the virtual tag includes various items of potential interest to the user such as the menu, availability and any specials or other offers. It is understood that users will require a communications capable computing device (e.g., smartphone) to receive and respond to the virtual tags being presented to them.

In one embodiment, an integrated full-search and storage approach via posted uploads of geolocation virtual tags, a search infrastructure stores each geolocation virtual tag posting element along with an associated geo-location. In addition, preprocessing of the elements enables extraction of search data for inclusion in the search database structures. By delivering a geo-location search input (i.e., a GPS location of a first mobile hand-held device), search results will be produced that will identify geolocation virtual tags with associated geo-locations in the vicinity of such geo search input. Such identified geolocation virtual tags can then be retrieved from server infrastructure storage and displayed on the mobile hand-held device.

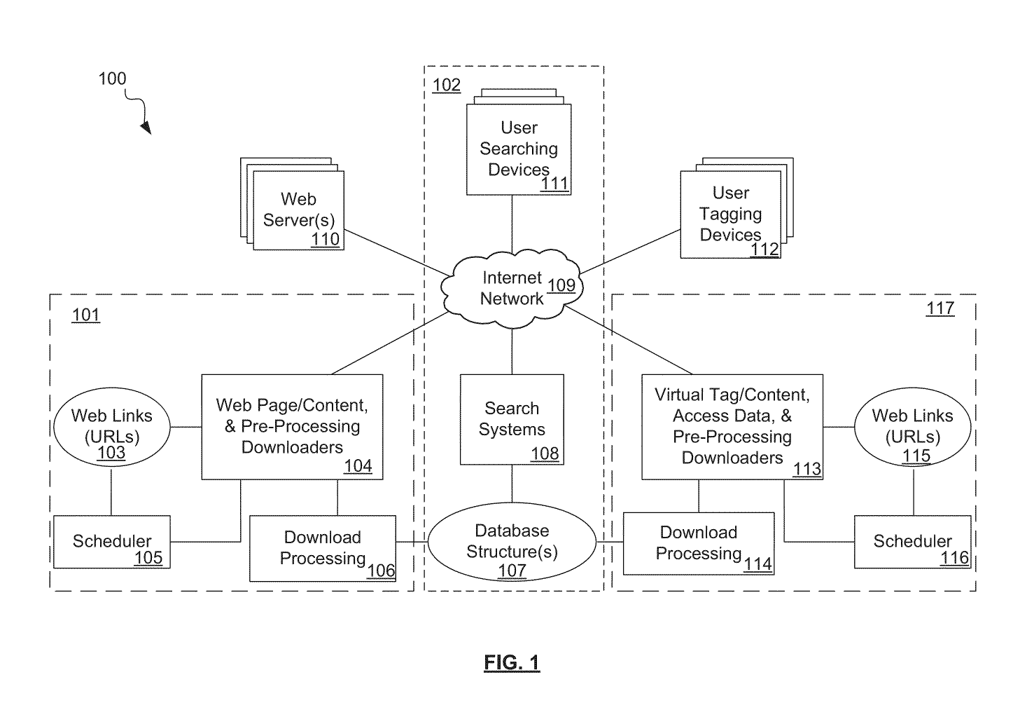

FIG. 1 illustrates one example embodiment of a system to support one or more elements of the technology described herein. System 100 includes web crawler 101 and search infrastructure 102. Web crawler 101 systematically browses the World Wide Web, typically for the purpose of building a database of web based content. Web crawler 101 uses a list of web links 103 such as uniform resource locators (URLs) to visit. The URLs are called seeds as they start a process of content discovery and typically are provided by domain registrations. As the crawler visits these URLs, one or more downloader(s) 104 parse the URLs to identify unique hyperlinks in the page which point to web server 110 stored content. URLs are typically recursively visited according to a set of policies which detect structure and content. As links are traversed, web pages and specific content are downloaded by downloader(s) 104 as per a schedule dictated by scheduler 105.

Downloader(s) 104, in one embodiment, further include preprocessing of webpages. Preprocessing, typically performed by web server(s) 110, includes extracting, in one embodiment, non-text information about images. For example, information about the image can be passed directly to the database structures 107 without needing the download processing 106. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor 106 reverse indexes a selected web page to encode web page words (e.g., frequency) and note location on the associated page (offset) so that content can be recovered (extracted) at a later time. The indexed data is transferred to a search engine database structure 107 where it is stored for later access by search systems 108. Search systems 108 receive Hypertext Transfer Protocol (HTTP) sequences to parse/hash database structures 107 to retrieve, for example, data, text, images, video, software, code, etc. HTTP is an application protocol for distributed, collaborative, hypermedia information systems.

Database structures 107 typically include indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 109 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 100 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 109 interconnects web servers 110 which store the various web pages and associated content to Web crawler 101 to the search systems 108 which use the indexed data to match a user input search string from a user search device 111 (e.g., smartphone, tablet, laptop, desktop or other known or future user devices with communications capabilities).

The system infrastructure is, in various embodiments described herein, also in communication with one or more GPS satellites and/or terrestrial geographic location systems (not shown) that provide the one or more communication devices with location information. In alternative embodiments, location information for one or more communication device is obtained using other information such as media access control (MAC) address, an internet protocol (IP) address, or the like.

In various embodiments of the technology described herein, system 100 includes geolocation virtual tagging. Geolocation virtual tagging includes virtual tag creation by user tagging devices 112 as will be described in greater detail hereafter. Once created, the geolocation virtual tags are stored locally (e.g., on the user tagging device 112 with a persistent IP address) or remotely (e.g., using the search infrastructure and/or in the cloud including third party servers).

Virtual tagging crawling system 117 mirrors Web crawling elements 101. Virtual tagging crawling system 117 accesses and parses stored geolocation virtual tags in much the same way a traditional web crawler would crawl a web page. The virtual tagging crawling system 117 includes, but is not limited to, one or more downloader(s) 113 which access, parse and process the virtual tags in a similar fashion to web pages for downloader 104. Downloader(s) 113 includes downloading of the virtual tag/content, access data and preprocessing of pointers/links (URLs) 115. The virtual tagging crawling system 117 further includes scheduler 116 to schedule the crawling of the geolocation virtual tags and download processor 114 to reverse index and distribute to database structures 107.

The technology described herein provides users with the ability to create geolocation virtual tags for various objects throughout the world. In further embodiments, a system infrastructure 100, as shown and described in FIG. 1, provides an infrastructure which stores each virtual tag posting element along with its associated geolocation. For example, upon receiving a geolocation search input (e.g., a GPS location of a first mobile communications device), the infrastructure applies the geolocation input to the search database, yielding a search result including those geolocation virtual tags having a geolocation in proximity to the geolocation search input. Such identified geolocation virtual tags can then be delivered from storage to the searching mobile device for presentation to the user. It is to be understood that the search infrastructure is, in one embodiment, created or provided by an independent entity such as an independent service, or integrated into conventional Web search infrastructures.

The virtual tagging system as described in FIG. 1 includes various elements described hereafter which can create, store, edit, manage, distribute and receive virtual tags associated with a geocoded (location tagged) data element (e.g., image, review, business, etc.). Virtual tagging includes, in one embodiment, adding electronic annotations to geocoded objects (e.g., leaving a review of a visited tourist spot like the Eiffel Tower). Tagging is performed with a user tagging device. Using an example smartphone, a user takes a picture, includes a notation about their experience, has the picture and notation geocoded to capture a user device position and uploads their just created virtual tag using the internet to be eventually indexed, stored and managed. Virtual tag data includes, in various embodiments, pictures, text, video, documents, profile information, personal information, public information, opinion, news, etc. Virtual tag data includes, for example, pictures of buildings or other objects of interest (e.g., family members, vacation spots, sporting events), posts such as social media, texts, tweets, journal-based entries, timelines, advertising, etc.

In addition to the location and data content, virtual tag data includes, in various embodiments of the technology disclosed herein, adding access restrictions. Restrictions include, but are not limited to, audience based restrictions such as limited access by a specific person, my family, social circles, aged based such as adults only or kids only, social groups, membership based, security based (e.g., must have password), distribution restrictions, time based (e.g., limited time only, time period, specific time of day, next few minutes, week, month, year, seasonable, etc.), number of accesses (e.g., can only view virtual tag 3 times, 3 times in a specified time frame (e.g., per day), location based, etc.).

Additional examples of access restrictions include, but are not limited to: payment for the geolocation virtual tag or associated service or product (e.g., coupon or discount when purchasing a geolocation virtual tag listed item (e.g., coffee from a menu or advertisement)); default access settings for the tagger (creator of geolocation virtual tag); a standard list of access limitations; a multi-tier access system (one access restriction at one level and another at the next level); classes of service; and templates with associated access restrictions.

Virtual tags, in various embodiments of the technology disclosed herein, include communication based options. For example, a tagger (geolocation virtual tag creator) includes a provision in the geolocation virtual tag to initiate a communication session directly with the viewer of the geolocation virtual tag (e.g., to order from a menu, select and purchase from a list of sale items, make a reservation, etc.). The communication session includes, but is not limited to, a chat frame, video conference, email, text, tweet, order template, or telephonic communication (e.g., voice call, voice over IP (VoIP) call, or downloaded audio message, etc.)

User tagging devices 112 include, but are not limited to: mobile phones; smartphones; tablets; laptops; desktops; or other known or future user computing devices with communications capabilities. In one or more embodiments disclosed herein, mobile communication devices are the recipients of geolocation virtual tags. These mobile communication devices are, in various embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in various embodiments, mobile communication devices are an access point, base station or other network access device that is coupled to a network such as the Internet or other wide area network, either public or private, via a wireline/wireless connection.

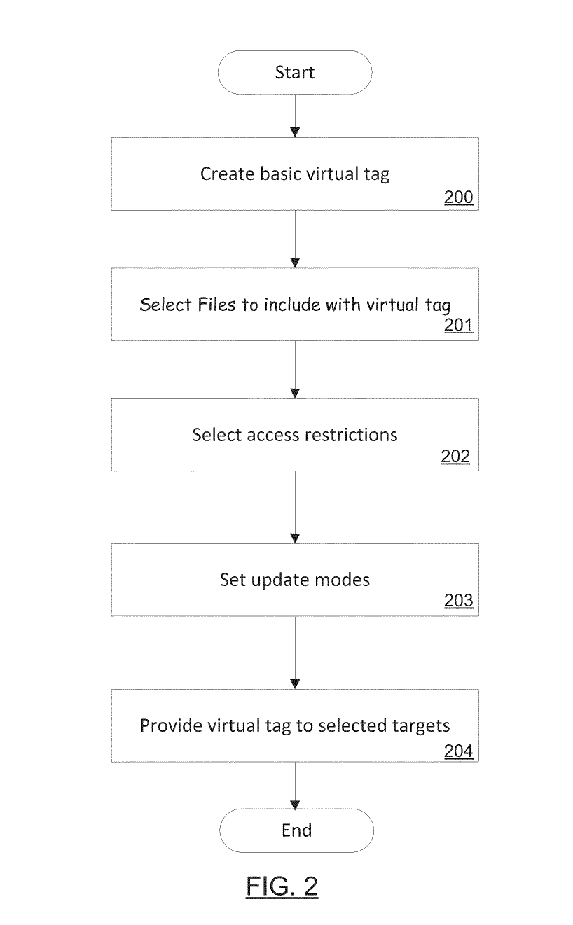

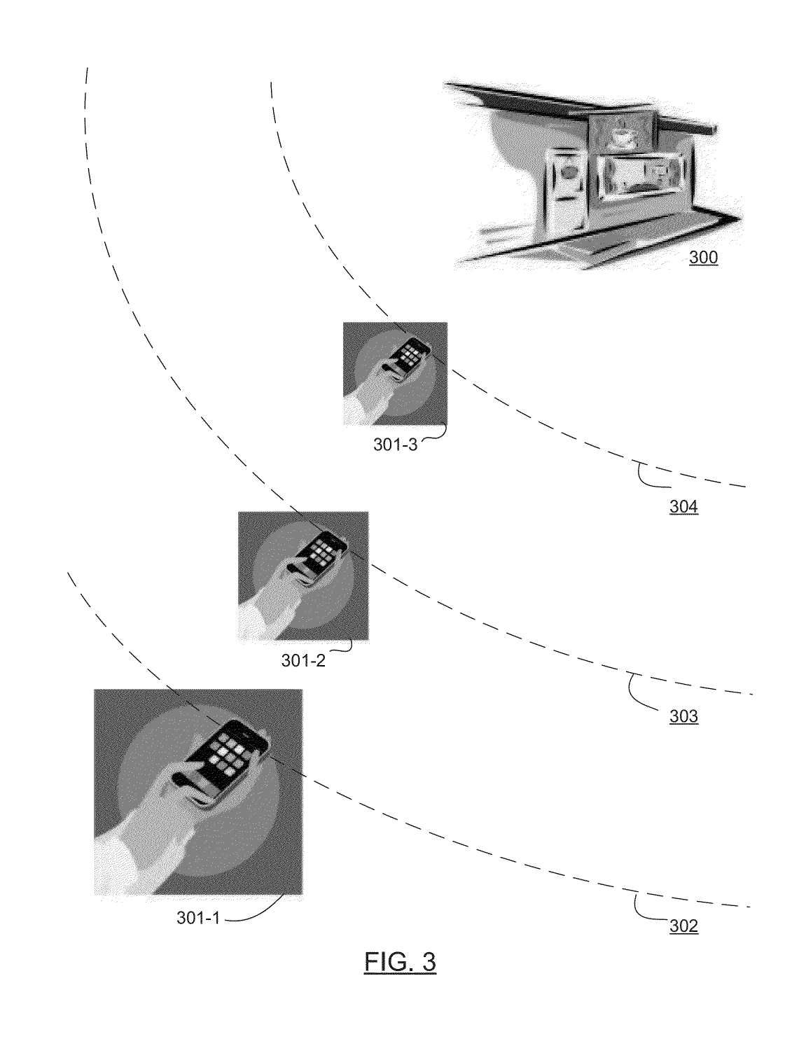

FIG. 2 illustrates a flow diagram showing one embodiment of the technology described herein of creating a geolocation virtual tag and providing the geolocation virtual tag to selected targets. In step 200, a basic geolocation virtual tag is created by a tagger (e.g., a business) as illustrated and described in greater detail hereafter in FIGS. 3-15 and associated description. A basic geolocation virtual tag includes at least the geolocation associated with the virtual tag and one or more annotations such as a message. In addition to the basic geolocation virtual tag, in various embodiments, the basic geolocation virtual tag is augmented to include additional data. In step 201, additional information, such as files, are added (attached) to the basic geolocation virtual tag being created. In various embodiments, the files include, but are not limited to: maps; directions; menus; specials; advertising; reviews; order templates; etc. In step 202, access restrictions are added to the geolocation virtual tag. Access restrictions include, but are not limited to: access to specific targets (customers); access based security; scheduling; and payment options. In step 203, update modes are added to the geolocation virtual tag. Update modes include whether to push or pull the geolocation virtual tag. In push mode, the geolocation virtual tag is transmitted (e.g., wirelessly) and in pull mode, the target customer comes across the virtual tag using a search function. In addition, in various embodiments, the update modes include, but are not limited to: coverage (e.g., distance away, radius, geographic zone, etc.); number of tags to dispense; management; motion vector characteristics; and trigger information. And finally, in step 204, the completed geolocation virtual tag is provided to selected targets (i.e., potential users of the tag (e.g., customers)) by pushing/pulling it over communication networks (e.g., wireless).

In one embodiment, advertising (attraction) is selectively applied and tailored. That is, it depends on user device capabilities, personal characteristics (male, female, old, young, educated, repeat customer, etc.), current activity (riding in a car, on a bike, jogging, walking, during work hours/weekend daytime/clubbing time, at a bar/restaurant, etc.) and recent past activity as well as prior behavior Also it is based on the user's current location.

One embodiment implementation of attract mode geolocation virtual tags includes a mode activated by a walking user (with mobile communications device) in association with a particular and somewhat distant geolocation virtual tag posting location. This mode is used to draw in a roaming user to a posting location such as by: presentation of a series of geolocation virtual tag posting that each trigger at different distances from the posting geo-location; periodic alerts such as direction pop-ups (arrows, turning audio, “only 100 m away” type notifications); and determining drive/walk-bys and responding by delivering additional alerts such as supplemental directions or otherwise providing posting data attempting to draw the walker back on track.

A further embodiment allows the user to define ranging parameters based on particular user types and user behaviors. For example, if a user with particular characteristics and/or behaviors approaches, a user utilizes the attract mode of operation or employs a modified attract mode (i.e., with different ranges). For example, if a user just visited a coffee shop for an hour, they can define ranges so that the system will not show postings concerning coffee hours for an explicit period of time (i.e., 6 hours). It is understood that alternative modes of operation are available to both the poster and to the viewer of the geolocation virtual tags.

FIG. 3 illustrates one embodiment of the technology described herein of receiving geolocation virtually tagged information based on location. As shown, a business (e.g., coffee shop) 300 wants to attract customers. The business (tagger) creates a geolocation virtual tag using a computing device with communications capabilities which is either hosted locally or remotely and is connected to the search system as shown in FIG. 1. A user 301-1 with a mobile communications device, for example a smartphone, approaches business 300 at radial distance 302 (e.g., 1600 ft.). The created geolocation virtual tag is either pushed or pulled (e.g., by searching) to the user at this distance if the geolocation virtual tag has a selected coverage area in this range. If the created geolocation virtual tag has a smaller radial distance coverage area (e.g., 800 ft.), user 301-2 receives the virtual tag at range 303. If the radial range is even smaller (e.g., 400 ft.), the virtual tag is received by user 301-3 at range 304. Users 301-1, 301-2, and 301-3 are, in various embodiments, the same customer as they approach business 300, different users or a combination thereof. For illustration purposes, the system is shown with three users, but the technology is not limited to a specific number of users.

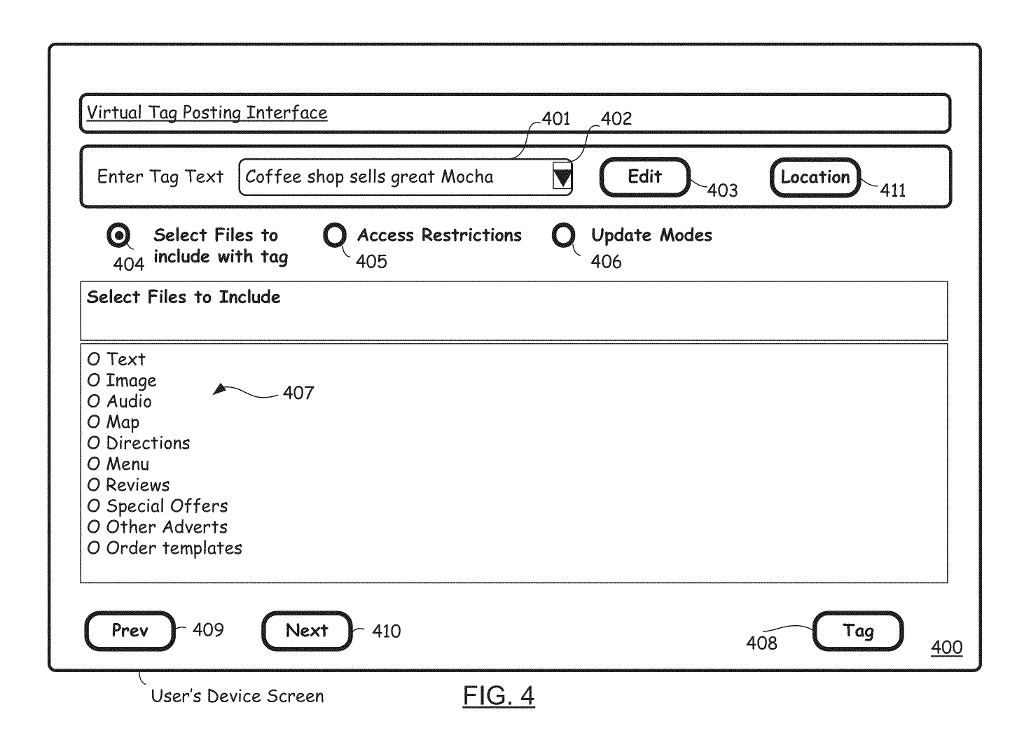

FIGS. 4-6 collectively illustrate various embodiments of creating geolocation virtual tags using a geolocation virtual tag posting interface. FIG. 4 illustrates a screen shot illustrating one embodiment of the technology described herein of a geolocation virtual tag posting interface including selection of files. As shown, FIG. 4 illustrates a user interface (UI) with geolocation virtual tag posting (shown as pop-up screen shot on a user's device) 400 for a geolocation virtual tag poster (seller, friend, etc.). Included are fields for typing in geolocation virtual tag text 401 or alternately selecting 402 and editing text 403 from a list of previously made geolocation virtual tags (including those made by the tagger, a third party and/or template tags). While shown for entering text, other forms of communication are within the scope of the technology described herein, such as images, video, audio, music, etc.). A basic geolocation virtual tag will automatically include the text and geolocation (location 411) associated with the virtual tag. In various embodiments, a user selects location button 411 which automatically attaches the location of the user's device (using known techniques, such as the device's GPS, coordinates, look-up address or equivalent known or future techniques) or provides the user with a text box to input their location or select their location from either a list or map.

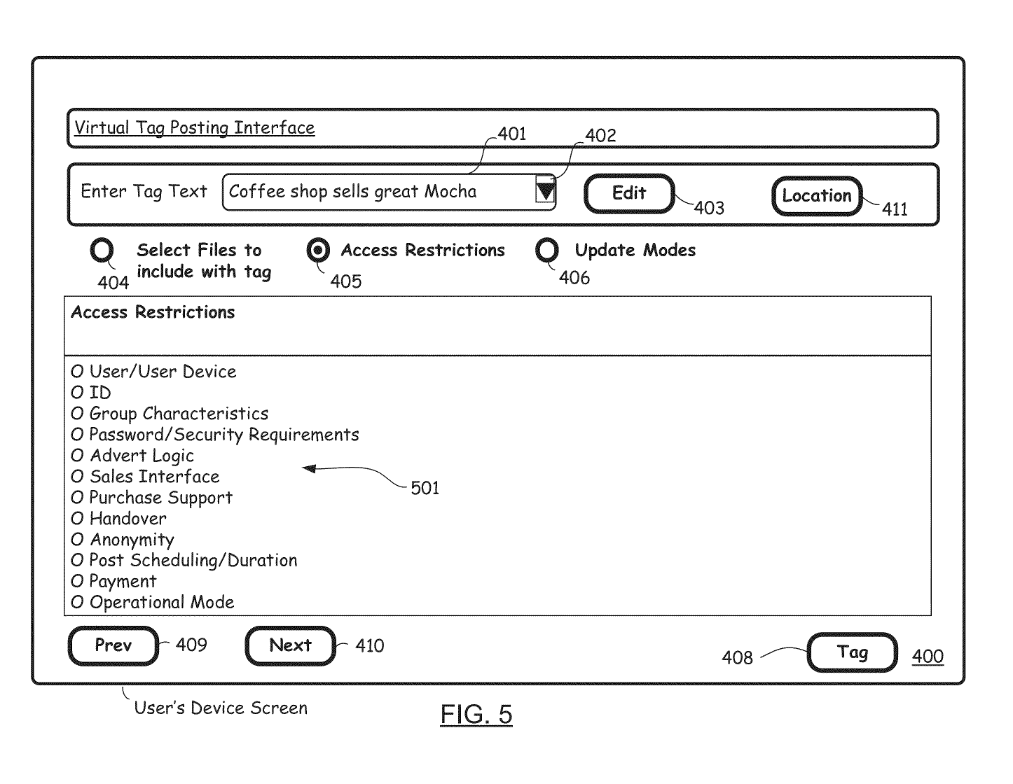

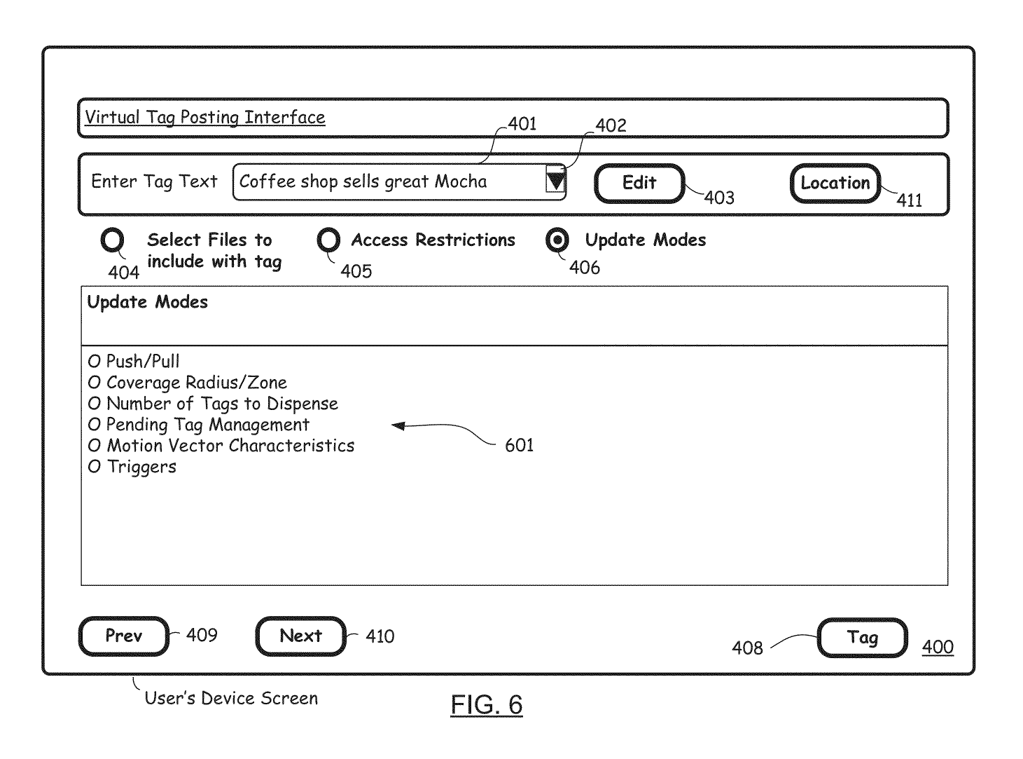

In addition, in one embodiment, it is possible to add one or more files to the geolocation virtual tag during creation 404. In various embodiments, the files 407 include, but are not limited to: text, images (e.g., pictures or video), audio (such as music or attention getting sounds like ring tones), maps, directions, menus, reviews, specials, advertising, order templates, purchase templates, etc. The technology described herein is not limited by a specific file or file type. It is envisioned that differing file types and associated content are equally within the scope of the technology described herein. Other UI selections include access restrictions 405 and update modes 406 which are described herein in greater detail with respect to FIG. 5 and FIG. 6 descriptions. Selections next 409 and previous 410 enable traversing a list of sequential or related geolocation virtual tags.

FIG. 5 illustrates a screen shot illustrating one embodiment of the technology described herein of a geolocation virtual tag posting interface including selection of access restrictions. As shown, FIG. 5 illustrates using the geolocation virtual tag posting interface 400 of FIG. 4 to provide access restrictions 405 on the geolocation virtual tag. Specific access restrictions 501 include, but are not limited to: one or more specific users/user-devices; identity (ID); group characteristics; password/security requirements; advertising logic selections (including attract mode behaviors); sales interfacing selections/behaviors; purchase support selections; handover selections; anonymity settings; post scheduling and duration; payment options for: associated advertising (incoming revenue), click through or sales completion fee collections/services (outgoing revenue); hosting/caching, etc.; operational modes including client hosted without caching and only pre-processing uploads, client hosted with no pre-processing, shared hosting, search system hosted.

FIG. 6 illustrates a screen shot illustrating one embodiment of the technology described herein of a geolocation virtual tag posting interface including selection of update modes. As shown, FIG. 6 illustrates using the geolocation virtual tag posting interface 400 of FIG. 4 to provide update modes 406 of the virtual tag. Specific update modes 601 include, but are not limited to: push (e.g., transmitting wirelessly), pull (search retrieves geolocation virtual tag in search results) or periodic pull (user device periodically pulls available geolocation virtual tags), and a mix of the two where push indication for need is followed up by scheduler with a pull; numerical or mapping interface that allows a poster to define either a coverage radius or any other odd shaped coverage zone (e.g., with support based on historical data illustrating the likely performance of such ad on a minute to minute . . . year to year, etc., basis); auto shut-down/pause behaviors (e.g., dispense this number of geolocation virtual tags per day or total then stop (and possibly discard)); pending tag management system to turn off or add more geolocation virtual tags (or search the user's own geolocation virtual tags—including search results populating a map with tag type icons and performance/status information modifying the icon look and feel); motion vector characteristics; and triggers.

Please note that FIGS. 4-6 represent, in various embodiments, possible posting selections. A basic geolocation virtual tag will typically comprise at least an annotation and location information. Additional virtual tag criteria selections, while not strictly required, provide a more sophisticated and possibly more effective virtual tag as the target audience is narrowed and/or focused. Any number of selections, restrictions and modes are envisioned within the scope of the technology described herein.

Coming into proximity of a highly posted location could result in posted virtual tags having no interest to the users. As a result, embodiments of the technology described herein comprise the necessary infrastructure to refine, modify and/or limit the resulting virtual tags.

In one embodiment, a mobile communication device user enhances the search input beyond that of merely geolocation based information. Users enhance the search infrastructure by adding support for various types of search annotations including text, video, image, audio, code, etc. Thus, a roaming user might pull up a virtual tag user interface (UI) and find 10,000+ virtual tag postings at a popular street corner or location. Instead of attempting to sift through everything, the user provides search input by, for example, taking a photo of a location (e.g., Coffee Shop) and typing in “review.” Such search input along with the user's geo-location, enables the search infrastructure to identify a small subset of the original 10,000+ postings. In certain embodiments, the user can sort the results by date, alphabetical order, type, and/or a combination thereof.

In one embodiment, filter tools are defined and applied to increase the likelihood of the search infrastructure identifying desired virtual tags. Filter tools include various settings that reject virtual tags that fall outside of particular filter settings.

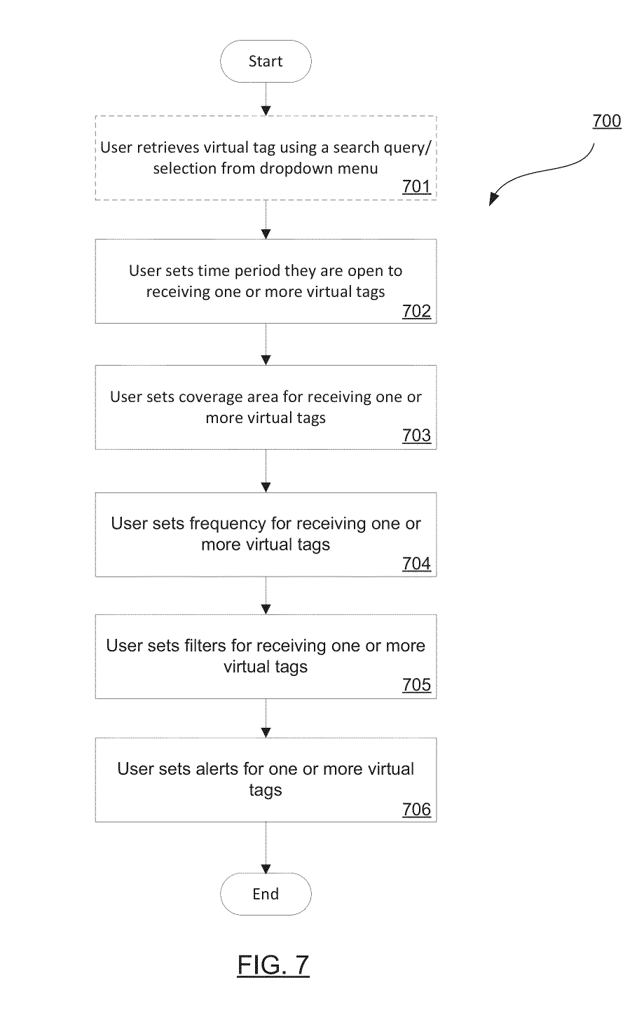

FIG. 7 illustrates a flow diagram showing one embodiment of the technology described herein of a geolocation virtual tag retrieval including setting of user preferences. A user, with communications device, who is interested in receiving geolocation virtual tags, sets their preferences for receiving geolocation virtual tags or alternately they set their preferences for a specific search string or a specific known tag or tag template. Using a virtual tag user interface (UI) provided on the user's communications device (e.g., smartphone), process 700 begins with optional step 701. In optional step 701, the user obtains a known virtual tag or tag category or template by various methods such as inputting a search query or selecting an existing geolocation virtual tag from, for example a drop down menu. The search inputs may include images, text, audio or a combination thereof. The search query is sent to the search system (see FIG. 1) from the user's communication device (e.g., user searching device(s) 411). Location information pertaining to the user's device present position is also sent to the search system to locate virtual tags in close proximity (e.g., within walking distance). The location information is provided to the network by a message sent from the user's communication device or other methods for communicating location information. In alternative embodiments, the location information is provided by a second mobile communication device. The search and location information are combined and transferred to the search system for processing (FIG. 1).

Referring again to FIG. 7, step 702 includes a user setting a time period that they are open to receiving one or more virtual tags. For example, a posting date range filter tool might be set to Jan. 1, 2012 through Mar. 1, 2012. Along with other search input and geolocation information, the search infrastructure would respond to a search request with only those virtual tags in proximity, matching the search input, and that were posted during the 2 months identified by the posting filter. Other types of filter tools might include virtual tag ratings, poster ratings, group member postings (social or ad hoc), posting content types, durations, etc. In step 703, the user sets the distance for receiving one or more virtual tags. For example, I am only interested in virtual tags which are present within 100 ft of my communication device as I walk through the city, 1600 ft. when I am in a rural area and 3-5 miles when I am driving in the car (as determined by rate of change in position or other known or future methods). In step 704, the user sets the frequency for receiving one or more virtual tags (e.g., hourly, daily, monthly, etc.). In step 705, the user sets additional filters for receiving one or more virtual tags (e.g., tags to avoid). Finally, in step 706, the user sets alerts for receiving one or more virtual tags (e.g., sound, text, tactile, etc.).

In one embodiment, to increase the value of geolocation virtual tagging, both search restriction setups and background searching with user alerts are used. In an example embodiment, a user interacts to define a series of searches (search input plus filter tool settings) of interest relating to coffee shops, computer stores, job opening postings, etc. One or more of the filters are set to run in the background with a specified (i.e., time and/or distance) or standard periodicity. Thus, as the user roams, such filters are each supplemented with current geo-location data (from the user via the user's hand-held device) and sent to the search infrastructure to fine proximate and relevant virtual tags. Once found, user alerts are used to draw the user's attention. Alerts are used for when a user is possibly engaged with other applications or has the mobile communications device in pocket, the background searching can continue in background and only alert if virtual tags become available. User alerts may include visual, audible, tactile (e.g., vibrations) or a combination thereof.

In various embodiments, overrides to user and tagger settings are useful. In one embodiment, a user may override geolocation virtual tag default ranges to prevent potentially annoying or repetitive geolocation virtual tag exposure. In another embodiment, advertisers may override geographic or coverage restrictions by bidding for a discrete coverage area (e.g., whole city, county, country).

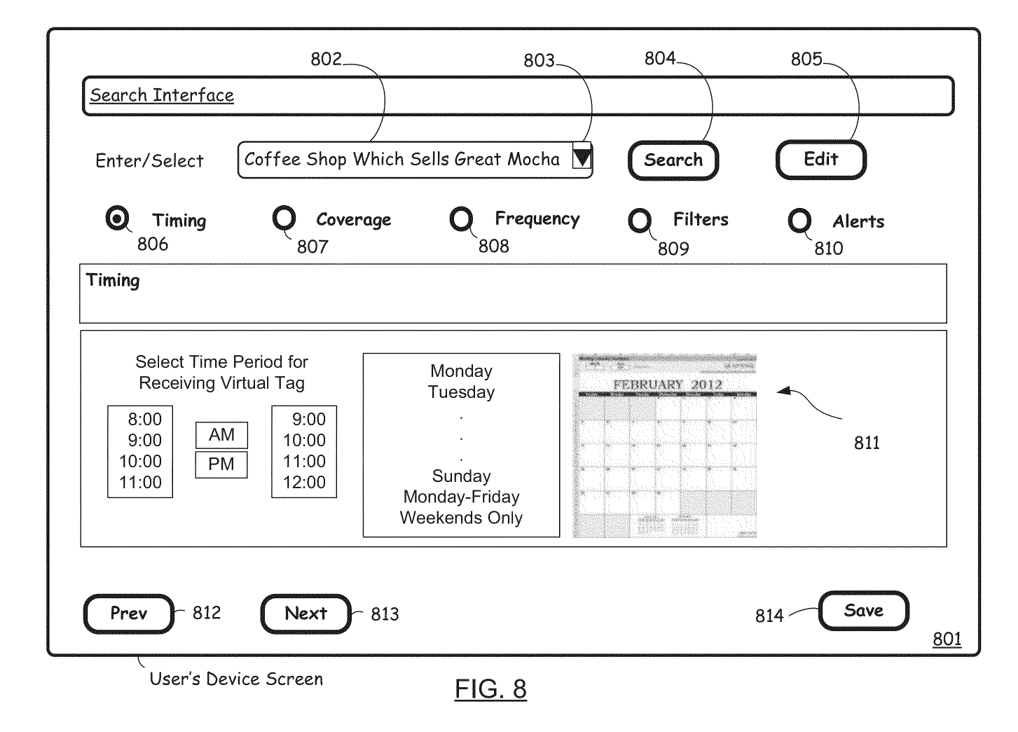

FIGS. 8-12 collectively illustrate one embodiment of a user interface (UI) to perform one or more of the method steps of FIG. 7. By illustrating a search interface on a user's device through which automated search behaviors are set up, they are managed and selectively/periodically launched behind the scenes by the user device or by a new node in the search service infrastructure. These behaviors, for example, involve preferences and filters relating to tag content. For example, a user might indicate a desire for coffee shop information every day between 6-8 AM, 11-2, 6-11 PM plus when within 200 meters when on foot, not Jo's Coffee Shop, not after having visited a coffee shop within the past hour, and with no repeat pinging (hysteresis) for a 24 hour period. That is, I should be able to define my own ranges beyond that defined by a poster (who may even have infinite range as I might have set as well). Virtual tags associated with a particular bank's ATM's, Chinese restaurants, etc., might be similarly configured and stored. These searches can then be applied upon drop down selection, automatically in background with alerts, or automatically when a browser/map is launched as tab entries.

In one embodiment, dating geolocation virtual tags, are presented to the receiver in stages, for example, in stage 1 a bio is provided, stage 2 contact info is provided, and stage 3 a date is scheduled (including location, directions, etc.).

FIG. 8 illustrates a screen shot illustrating one embodiment of the technology described herein of a geolocation virtual tag search interface including user preference setting of timing. Referring to FIG. 8, search interface 801 shown on a user's device screen (e.g., smartphone), includes fields 802 for entering a search to locate geolocation virtual tags of interest, including, but not limited to: text; video; images; audio; code; etc. Selecting search 804 or alternatively selecting 803 a geolocation virtual tag from a drop down menu which can be edited 805 initiates a search process. Search results are narrowed, in various embodiments, by selecting one or more user preferences to include, but not limited to: timing 806; coverage 807; frequency 808; filters 809; and alerts 810. Preferences include user specific choices, standardized, default, or third party provided preferences (e.g., preferences from a study of effective preferences). As shown, timing preferences 811 include specific times or time periods. For example, a user selects a specific time to view virtual tags (using only a first column time selection) or a time period by selecting from both a first and second time column. As is known, AM/PM is selected as desired. In addition to specified times, one may select specific days of the week, a typical work week (M-F), weekends only (Sat/Sun) as well as a selection from a calendar. It should be noted, that common or customized time related preferences are considered within the scope of the technology described herein, however, other time based preferences can be substituted without departing from the scope of the technology described herein. As previously discussed above, the various user preferences are set in various embodiments for generally receiving geolocation virtual tags (i.e., my preferences for any proximate geolocation virtual tag), attached to specific search strings, specific geolocation virtual tags or for geolocation virtual tags belonging to a specified set (e.g., want to receive coupons), or a specific template (e.g., menus). When completed a user saves their preferences 814 and optionally moves to the previous 812 or next 813 user preferences screen.

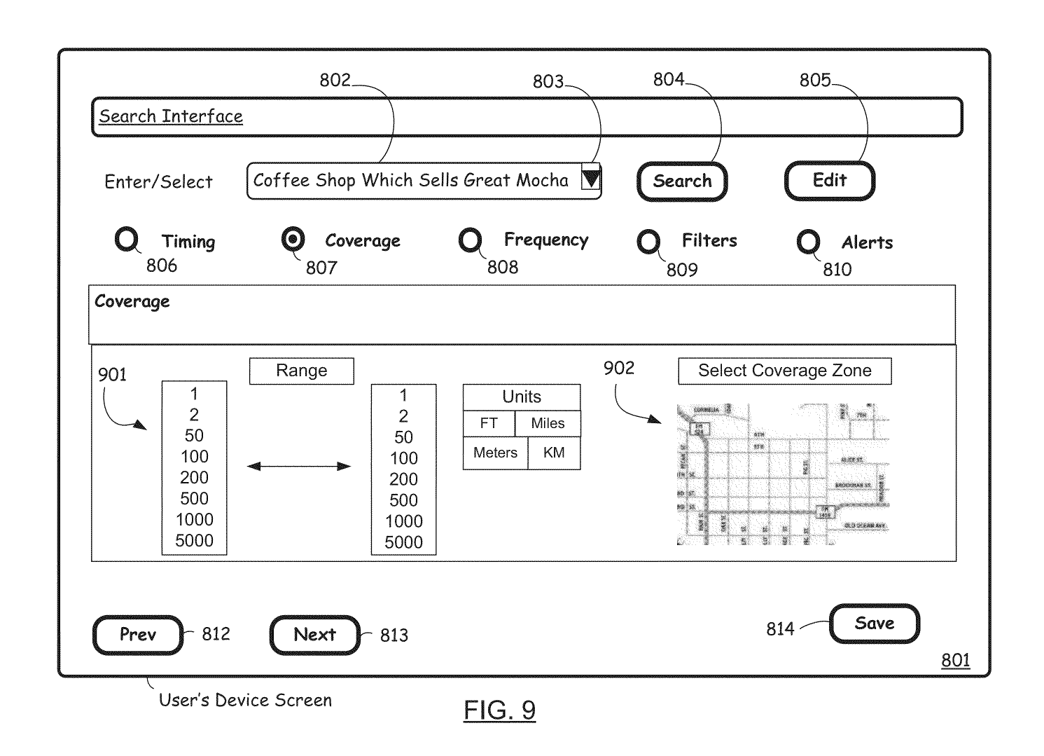

FIG. 9 illustrates a screen shot illustrating one embodiment of the technology described herein of a geolocation virtual tag search interface including user preference setting of coverage. As shown, FIG. 9 illustrates search interface 801 shown on a user's device screen (e.g., smartphone) with selection of coverage preferences 807. Specific coverage preferences are included to narrow the geolocation virtual tag receiving area. For example, I am only interested in geolocation virtual tags which are in close proximity (the definition of close proximity may be variable from user-to-user based on their individual preferences). As shown, coverage is manually selectable, in various embodiments, by selecting a specific distance 901, typically radially, from the user. For example, show me only geolocation virtual tags from 1-100 ft away from me (based on detected position of my communications device). In an alternative embodiment, a coverage area or zone is chosen using conventional map area 902 selection techniques. It is envisioned that differing coverage preferences are equally within the scope of the technology described herein.

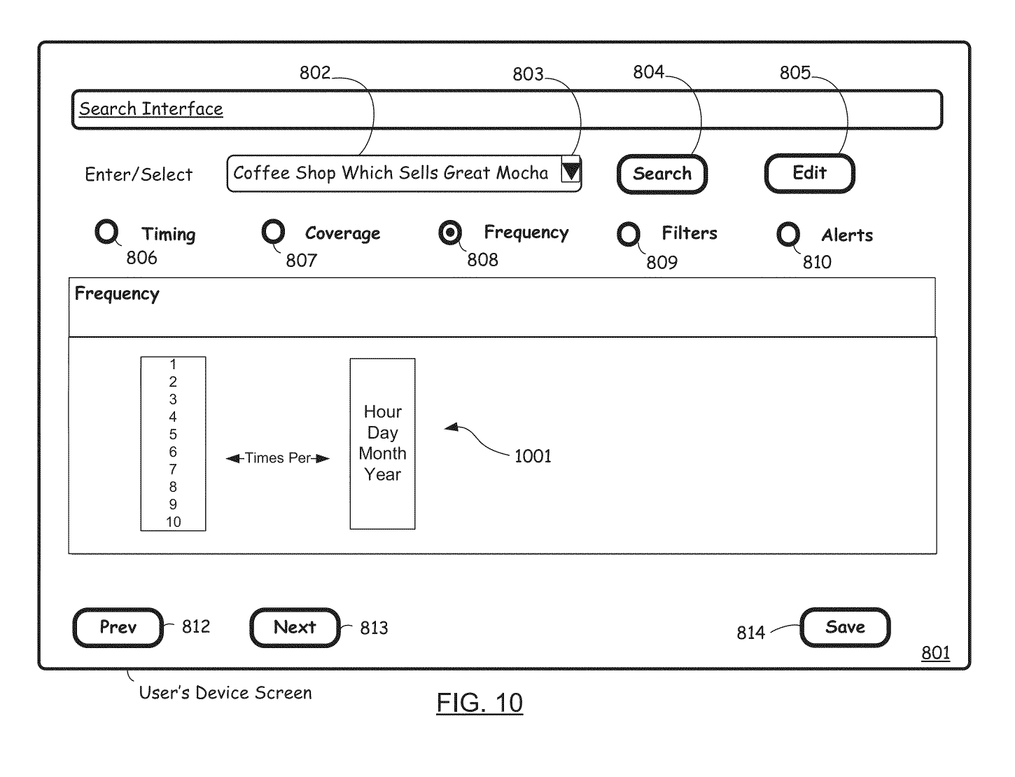

FIG. 10 illustrates a screen shot illustrating one embodiment of the technology described herein of a geolocation virtual tag search interface including user preference setting of frequency. As shown, FIG. 10 illustrates search interface 801 shown on a user's device screen (e.g., smartphone) with selection of frequency preferences 808. Specific frequency preferences 1001 allow a user to narrow their search and subsequent number of geolocation virtual tags received by only receiving geolocation virtual tags a specified number of times per some specified time frame. For example, I want to see geolocation virtual tags only twice per day. In alternative embodiments, a user may select from either standardized frequencies or from recommended or suggested ideal frequencies for a specified period. Without preference selection, a user in various embodiments would become overwhelmed with a never ending repetition of the same advertisement or a category of geolocation virtual tags. It is envisioned that differing frequency selections are equally within the scope of the technology described herein.

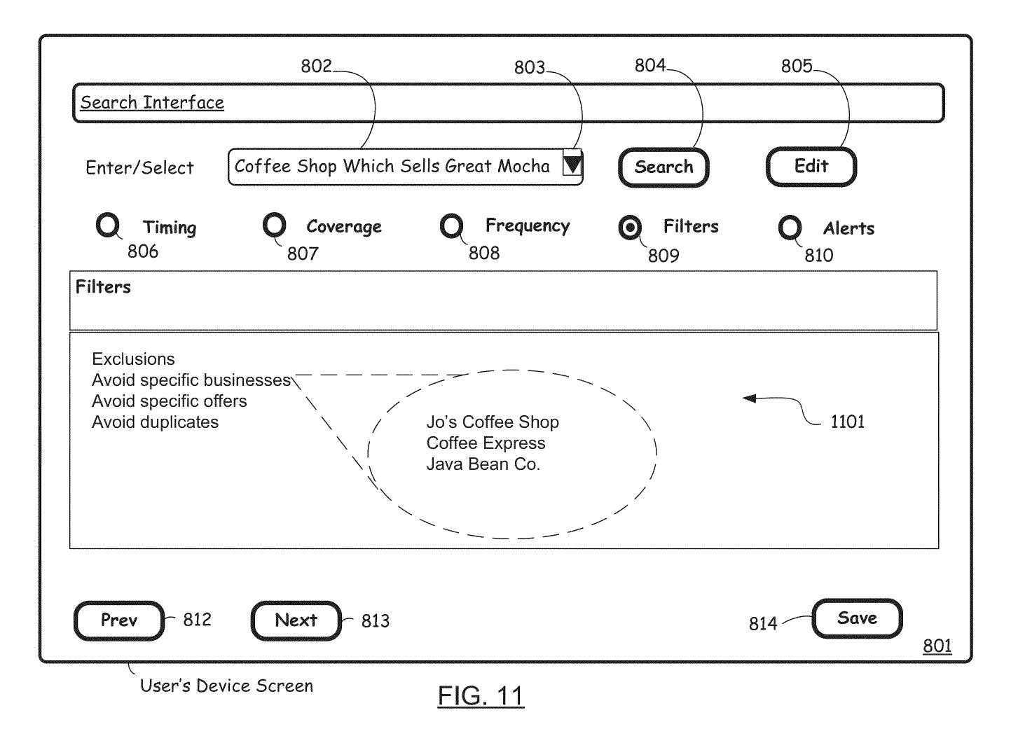

FIG. 11 illustrates a screen shot illustrating one embodiment of the technology described herein of a geolocation virtual tag search interface including user preference setting of filters. As shown, FIG. 11 illustrates search interface 801 shown on a user's device screen (e.g., smartphone) with selection of filter preferences 809. Specific filter preferences 1101 allow a user to narrow their search and subsequent number of geolocation virtual tags received. A user, in various embodiments avoids specific businesses (e.g., Jo's Coffee Shop), specific offers (e.g., no coffee offers if they don't drink coffee) or duplicate tags. It is envisioned that differing filters are equally within the scope of the technology described herein.

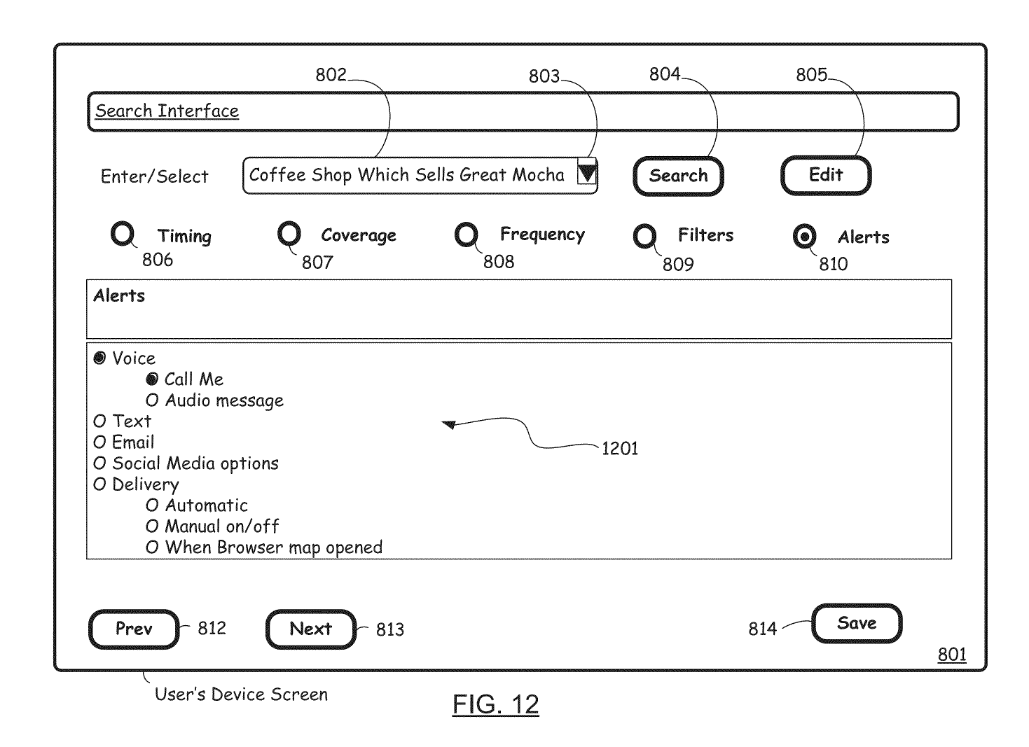

FIG. 12 illustrates a screen shot illustrating one embodiment of the technology described herein of a geolocation virtual tag search interface including user preference setting of alerts. A shown, FIG. 12 illustrates search interface 801 shown on a user's device screen (e.g., smartphone) with selection of alert preferences 810. Specific alert preferences 1201 allow a user to select how they will be notified of geolocation virtual tags received. A user, in various embodiments will set alerts such as, but not limited to: voice (such a call or audio message); text (such as SMS text messaging); email; social media options (e.g., Facebook®, Tweets®, Instagrams®, etc.); and be able to select delivery methods, such as, but not limited to automatic, manual (on/off) and/or when browser map is opened. It is envisioned that differing alerts are equally within the scope of the technology described herein.

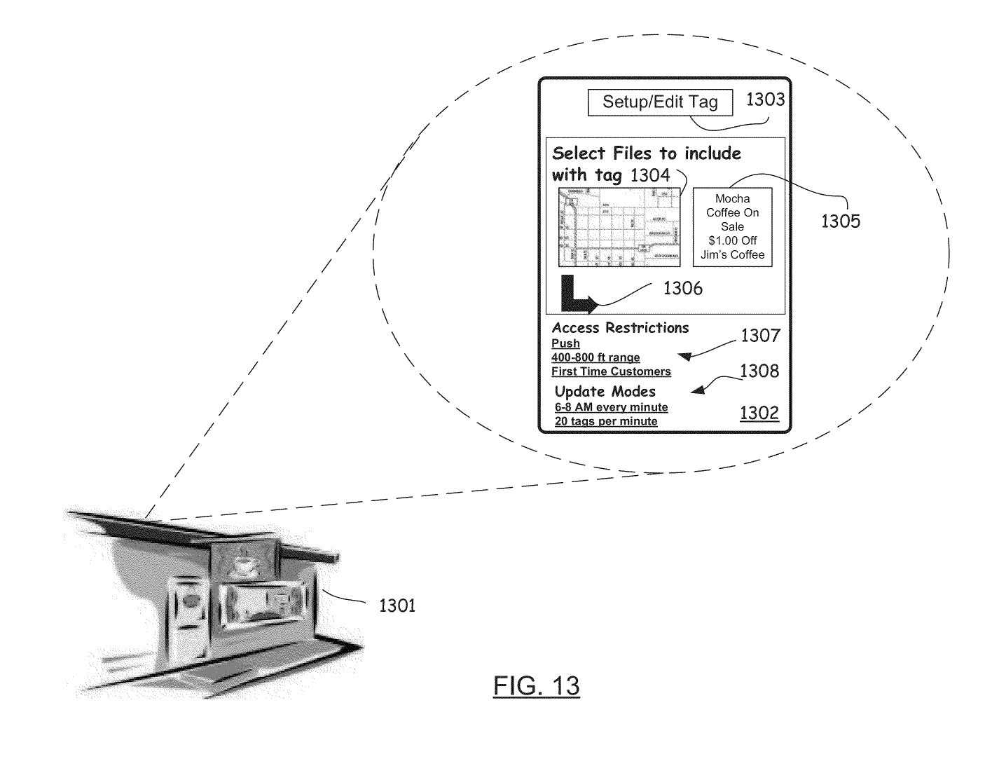

FIG. 13 illustrates a screen shot illustrating one example embodiment of the technology described herein of a geolocation virtual tag posting. As shown, FIG. 13 illustrates an example embodiment screen shot 1302 for a virtual tag poster using the system and method of the technology described herein. As shown, a tagger (merchant) 1301, such as Jim's Coffee, creates 1303 or selects an existing geolocation virtual tag which includes their specific geolocation (or multiple locations for multiple franchises). In this example, they add three files to the virtual tag. A first file is a map 1304 with their merchant name and location. A second file includes a product offer 1305 for purchase. A third file (comprising a set of directional graphics) is selectively used by the system to provide directional alerts (such as arrows 1306). They then add access restrictions 1307 including: pushing the virtual tags to approaching potential customers; selecting a sweet spot range of 400-800 ft., and only first time (new) customers. Update modes 1308 are set at 6-8 AM with periodicity of every minute and 20 virtual tags per minute.

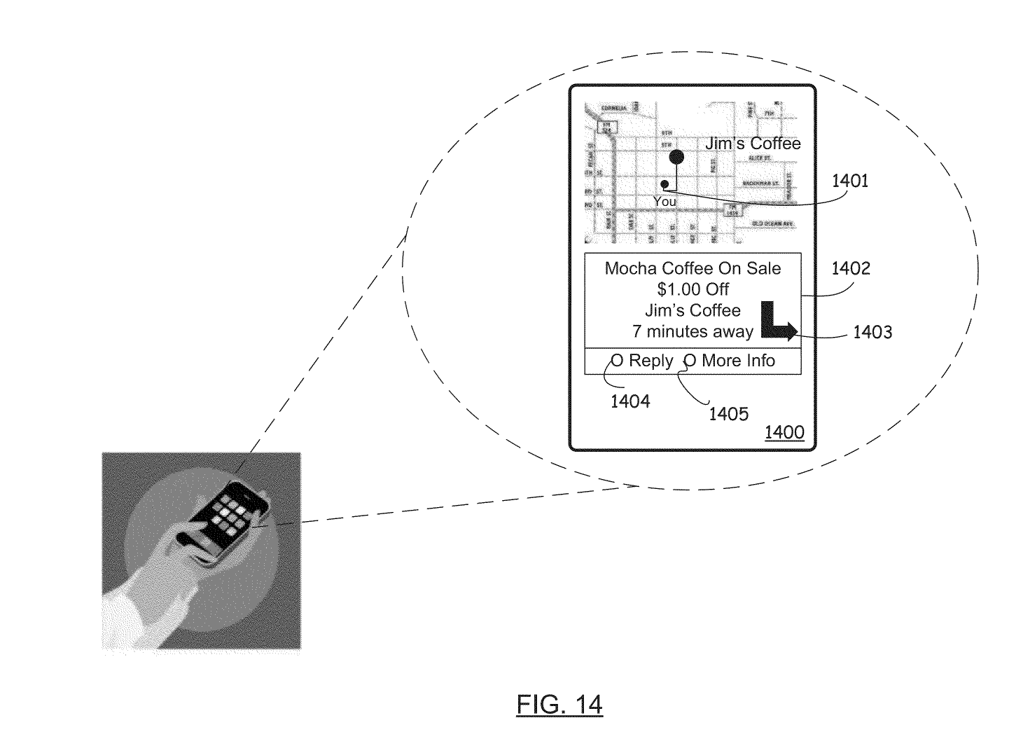

FIG. 14 illustrates an example embodiment screen shot 1400 of the geolocation virtual tag resulting from the geolocation virtual tag post from FIG. 13 using the system and method of the technology described herein. As shown on a user's mobile device screen 1401 (e.g., smartphone screen), when the user walks into Jim's Coffee's coverage area (400 ft. radius), and they are accepting geolocation virtual tags, they first receive an alert that a geolocation tag is available for viewing. Alerts may be audible, visible or tactile. Selection of a geolocation virtual tag produces a pop-up frame on their device screen including map 1304 showing their position 1401 relative to Jim's Coffee, visual directions (e.g., arrows) 1403, an image of the advertising offer 1402, and two choices (a reply selection 1404 which allow them to communicate directly with the business (e.g., engage in a chat session). In addition, they have the option to request additional info 1405 (e.g., a menu or other offers which are available).

In one exemplary embodiment, a real time communication channel(s) (window) is opened between an advertiser and a potential customer in a controlled manner. Communication channels are voice, video conference, text chat, and/or white board type links available to underpin and enhance “attraction.” Windows open up with staged media as a user gets closer or further away, e.g., larger incentive as you are moving further from the coffee shop. A window that opens could be used to take orders or delivery comments. This interaction vehicle breaks anonymity in advertising. It allows the interaction to be interactive, communicative and personalized as opposed to traditional advertising that is pushed at the consumer typically with little understanding of its affect.

In an example embodiment, the potential customer receives the coffee shop virtual tag due to their predefined tag searching functions plus associated prediction algorithms when they are in walking distance from the coffee shop. They are offered a video conference link, phone call link, text chat and white board communication option. They also receive a menu and ordering interface. Instead of interacting with the touch screen to place their order, they select the phone call link. The phone mode kicks in and they hear “Jim's Coffee, can I help you.” They say they want to order a giant espresso. They are then asked to reveal their identity, accept payment due processing charges, and allow tracking for just in time coffee preparation (ready upon their arrival) by clicking on the button on their screen (pushed by the retailer Yes/No/Cancel/Hang-Up).

Anonymity is often important to potential buyers, with an ability to block their identity from otherwise nagging and persistent sellers. In the above example, before clicking, the seller has no idea who or where the customer is (anonymity). In one embodiment, a proxy server will change a customer device's IP address to disguise their identity. Once the customer clicks “Yes”, an automatic digital wallet payment is transferred, their identity and position is revealed (which shows up on a map with arrival timing prediction for the seller to see). The customer will see a map with a coffee ready in 4 minutes 29 seconds, a type of countdown indication with a predicted arrival time number there beside and a mapping interface that directs them to the door. In other words, staged anonymity and interactions in various ways can be managed between the seller and a potential buyer.

In an alternative embodiment, video frames are offered up as part of the virtual tag posting. A recipient selecting a tag may then engage any one of such frames through which communication with someone at the site of the tag poster (e.g., a coffee shop) can be established. Also included would be advertising information (e.g., menus, price lists, goods/services offerings, promotion info (coupons, rebates, etc.) through which sales transactions can be launched and completed (immediately or upon reaching the brick and mortar location). In one embodiment, an interaction that may start out fully anonymously is followed by agreements to engage with identities revealed on either or both sides.

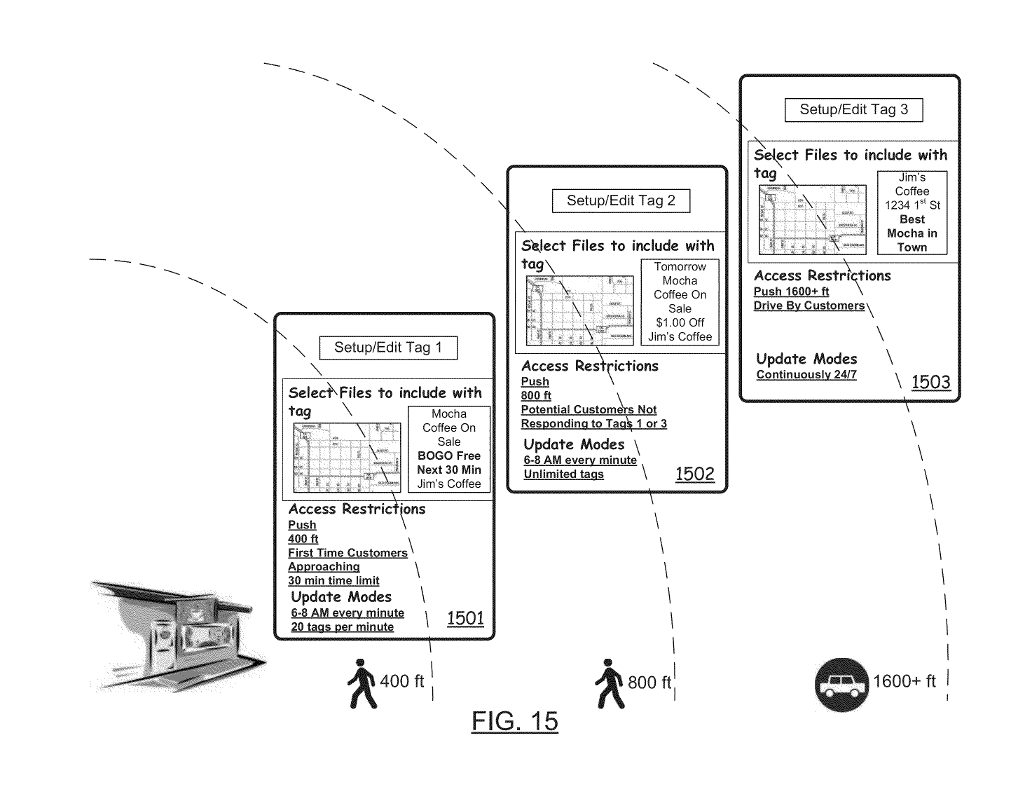

FIG. 15 illustrates an example embodiment multilevel strategic use of geolocation virtual tags using the system and method of the technology described herein. As shown, the merchant creates a more complex series of interactions with potential customers. In this example embodiment, some types of virtual posts might exist over a first larger region to be consumed by a certain type of user with a certain type of user device. If they express no interest, include an inner range where a second geolocation virtual tag look and feel/content is delivered, and include third outer range where a third type of geolocation virtual tag is delivered. By tracking motion (motion vectors), user activity, and user interaction data with their user device, further ad selection/tuning can take place. Selecting between the different geolocation virtual tags look and feels/types can be fully handled locally with all three being sent at once. Another approach is to handle such logic and staged delivery within the central search system. A simple approach would be to determine the distance to the destination, whether an ad has been looked at or not, whether the distance is closing or expanding, and determine how to follow-up. An ad good for tomorrow might be appropriate for a walk away. A buy-one-get-one (BOGO) free if purchased within the next 30 minutes for someone walking toward. For a drive by, no promotions but only a general ad. In an alternative embodiment, customer specific history or aggregated as a group is also taken into account. If a buyer approaches daily and all offers have been rejected, do not include ads. If a return customer, a brand loyalty type ad that even offers up “the usual” for streamlined ordering.

Referring again to FIG. 15, geolocation virtual tag 1 (1501) is set-up to trigger at 400 ft., geolocation virtual tag 2 (1502) is set-up to trigger at 800 ft. and geolocation virtual tag 3(1503) triggers at 1600+ft. In this example embodiment, a plurality of geolocation virtual tags are created by the merchant (e.g., coffee shop), the tags are uploaded to the search infrastructure for indexing and the search system provides geo-based search results at a defined distance from the merchant. The various offers are tailored to match both the proximity and the user's behavior. For example, geolocation virtual tag 1 offers BOGO free for the next 30 min for close proximity first time customers approaching the merchant on foot; geolocation virtual tags 2 offers a coffee sale the next day for potential customers not responding to tags 1 or 3; and geolocation virtual tag 3 offers just a quick general sales message for potential customers far away and travelling by car. It is envisioned that differing combinations of posting and potential customer (user devices) settings are within the scope of the technology described herein.

While the figures include various screen shots such as posting and setting user preferences to provide various settings and selections, it is understood that the technology described herein is not limited by these specific construction techniques, settings or selections. Functionally equivalent, known and future, constructs, settings and constraints are interchangeable without departing from the scope of the technology described herein. For example, the posting and search interfaces, in various embodiments, share some or all of the same settings and selections or the aggregate of the two interfaces. In one exemplary embodiment, geolocation virtual tag construction uses web site creation tools simplified for quick composition. In other words, geolocation virtual tags piggy back on web creation tools using html/xml or functional equivalents, which inherently include files, access browser add-ons, etc., and are consumed by typical web browsers.

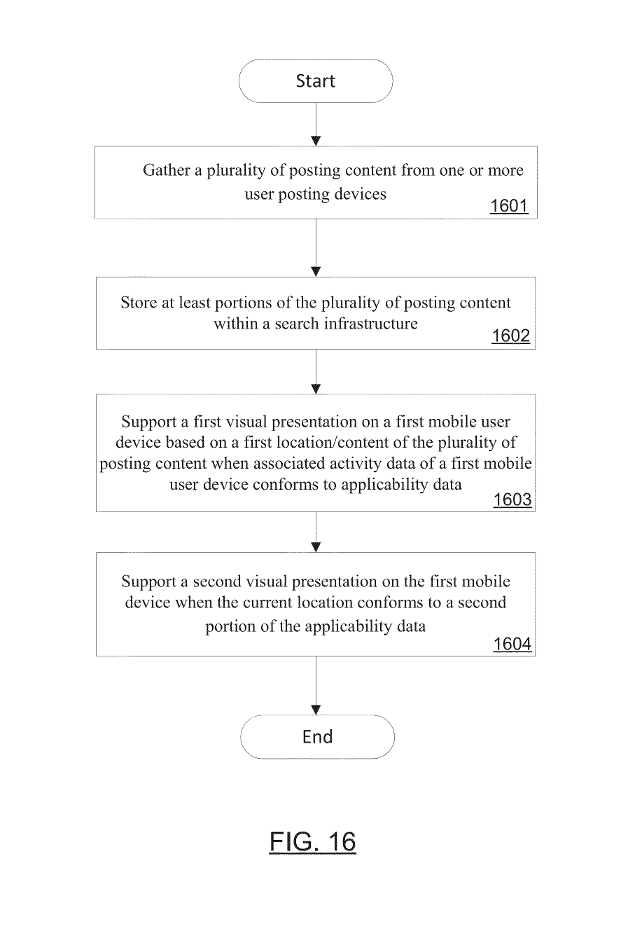

FIG. 16 illustrates an example embodiment flow diagram of using the search infrastructure of the technology described herein. In a first step 1601, the search infrastructure (FIG. 1) gathers (using virtual tag/content crawler 117) a plurality of posting content from one or more user posting devices (user tagging devices 112). The plurality of posting content comprises at least associated applicability data (such as geolocation (geographic location), distance from merchant, mode of travel (e.g., on foot, by car, etc.), access limitations, preferences, customer history, etc.). In addition, the plurality of posting content has content such as merchant offers, maps, etc. In step 1602, portions (e.g., indexed and/or preprocessed data) of the plurality of posting content is stored within the search infrastructure (e.g., within database structure(s) 107). In step 1603, a first visual presentation (e.g., first merchant offer) on a first mobile user device 111 is presented based on at least a first content of the plurality of posting content when associated activity data of the first mobile user device conforms to the first applicability data. In step 1604, a second visual presentation is supported on the first mobile device when the associated activity (e.g., geographic location) conforms to a different (second) portion of the applicability data.

In an embodiment of the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other known or future wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other known or future mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the mobile communication device.

A wireless local area network (WLAN) links two or more devices using some wireless distribution method (typically spread-spectrum or OFDM radio), and can provide a connection through an access point to the wider Internet. This gives users the mobility to move around within a local coverage area and still be connected to the network. Most modern WLANs are based on IEEE 802.11 standards.

Throughout the specification, drawings and claims various terminology is used to describe the various embodiments. As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the terms “virtual tags” and “tags” are considered equivalent. The terms “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

In an embodiment of the technology described herein, receiver and transmitter processing modules are implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. In some embodiments, the associated memory is a single memory device or a plurality of memory devices that are either on-chip or off-chip. Such a memory device includes a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. The technology as described herein is not limited by the particular examples disclosed herein and expressly incorporates these other combinations.

1. A method performed by a search service, the method comprising:
gathering a plurality of posting content from one or more user posting devices, the plurality of posting content comprising at least associated applicability data, the plurality of posting content having first content and first applicability data;
storing at least portions of the plurality of posting content within a search infrastructure;
supporting a first visual presentation on a first mobile user device based on the first content of the plurality of posting content when associated activity data of the first mobile user device conforms to the first applicability data.

2. A method, as per claim 1, further comprising supporting a plurality of user computing devices in interactions involving the first mobile user device.

3. A method, as per claim 1, further comprising the associated activity data comprising motion data and the associated applicability data comprising associated applicable activity data.

4. A method, as per claim 3, further comprising the associated activity data comprising geo location information and the associated applicability data comprising associated applicable geo location data.

5. A method, as per claim 4, further comprising the first visual presentation including annotations related to the associated applicable geo location data.

6. A method, as per claim 4, further comprising the first visual presentation including mapping information related to the associated applicable geo location data.

7. A method, as per claim 1, further comprising the supporting step supporting user anonymity.

8. A method, as per claim 1, further comprising the first visual presentation including advertising.

9. A method performed by a search service to support a first mobile user device of a first user and a remote user device of a second user, the method comprising:
storing in a search infrastructure at least portions of tag content and geo-location related data, the tag content being supplied by the remote user device through interactions at a first posting location;
supporting a first visual presentation on the first mobile device based on at least a portion of the tag content when a current location of the first mobile device conforms with the geo-location related data, the first visual presentation offering an interface through which the first user and the second user may communicate.

10. A method, as per claim 9, further comprising the interface supporting staged anonymity.

11. A method, as per claim 9, further comprising the interface comprising a video conferencing interface.

12. A method, as per claim 9, further comprising the interface comprising a voice interface.

13. A method, as per claim 9, further comprising the interface comprising a text based interface.

14. A method, as per claim 9, further comprising the first visual presentation triggered at predetermined distance intervals based on the first location of the first mobile device relative to a second location.

15. A method, as per claim 9, further comprising the first visual presentation including navigational instruction.

16. A method, as per claim 9, further comprising the supporting step supporting payment options.

17. A method, as per claim 9, further comprising the further comprising the first visual presentation triggered by user preferences of the first user.

18. A method performed by a search service to support a plurality of user computing devices by attracting a first roaming user of a first mobile device having a current location, the method comprising:
gathering a plurality of posting content from one or more user posting devices, each of the plurality of posting content having associated geographic applicability data, and first content of the plurality of posting content having first geographic applicability data;
supporting a first visual presentation on the first mobile device based on at least a first portion of the first content when the current location conforms with a first portion of the first geographic applicability data; and
supporting a second visual presentation on the first mobile device when the current location conforms to a second portion of the first geographical applicability data.

19. A method, as per claim 18, further comprising the supporting step supporting user anonymity.

20. A method, as per claim 1, further comprising at least one of the first visual presentation and the second visual presentation including advertising.
